(19) United States
(12) Patent Application Publication
(10) Pub. No.: US 2005/0098984 A1
(43) Pub. Date: May 12, 2005

(54) Airbag device

(75) Inventor: Shinzo Matsumura, Tokyo (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 10/981,547

(22) Filed: Nov. 5, 2004

Related U.S. Application Data
(60) Provisional application No. 60/517,913, filed on Nov. 7, 2003.

(51) Int. Cl. B60R 21/16

(52) U.S. Cl. 280/728.1

(57) ABSTRACT

An airbag device for protecting an occupant of a vehicle. The airbag device includes a passenger airbag configured to deploy in a direction toward a vehicle occupant in an event of a vehicle emergency. When fully deployed, the passenger airbag includes a projected area facing a vehicle occupant. The projected area of the passenger airbag is 1.0 to 1.4 times a projected area of a 50^{th} percentile adult male dummy.

### CROSS REFERENCES TO RELATED APPLICATIONS

This application claims the benefit of U.S. Provisional Application No. 60/517,913, filed Nov. 7, 2003.

### BACKGROUND

The present invention relates to an airbag device in which an airbag is inflated to protect a vehicle occupant in the event of a vehicle emergency, such as a collision. More particularly, the present invention relates to an airbag device intended to protect a vehicle occupant more efficiently by making the projected area of the airbag close to the projected area of an actual occupant while allowing the occupant to escape from the vehicle immediately after inflation of the airbag.

An airbag for protecting a vehicle occupant is usually stored in a folded state in a recess disposed in the middle section of a steering wheel of a vehicle or within an instrument panel of a vehicle. In the event of a vehicle emergency, such as a collision, the airbag is deployed and inflated in the vehicle interior by gas produced by an inflator. The inflated airbag receives and retains an occupant.

In a conventional airbag, the projected area of the airbag relative to an occupant is not set in an appropriate range. For example, a conventional airbag may have a large volume, but the projected area of the airbag relative to the occupant is small. Therefore, the airbag is not able to fully restrain the occupant. Conversely, as shown in FIGS. 3 and 4, a conventional airbag A may have a large projected area, but the volume of the airbag A is too large, which increases the cost and makes it difficult for an occupant to escape from the vehicle after the airbag inflates.

### SUMMARY OF THE INVENTION

According to an embodiment of the present invention, an airbag device is provided. The airbag device includes a passenger airbag stored under normal conditions. In the event of an emergency, the passenger airbag is inflated and deployed toward an occupant. The projected area of the passenger airbag is 1.0 to 1.4 times the projected area of a 50^{th} percentile adult male dummy.

According to another embodiment of the present invention, an airbag device is provided. The airbag device includes a twin airbag stored under normal conditions. In the event of an emergency, the twin airbag is inflated and deployed toward an occupant. The projected area of the twin airbag is 1.0 to 2.0 times the projected area of a 50^{th} percentile adult male dummy.

Thus, an embodiment of the present invention is able to protect an occupant more efficiently by making the projected area of the inflated airbag close to the frontal area of an actual occupant while allowing the occupant to escape from the vehicle immediately after the inflation of the airbag. Therefore, the projected area of the airbag when the airbag is deployed is compared to the 50^{th} percentile adult male dummy for fully restraining the occupant, and the projected area is set so the airbag does not become too large.

It is to be understood that both the foregoing general description and the following detailed description are exemplary and explanatory only and are not restrictive of the invention claimed.

### BRIEF DESCRIPTION OF THE DRAWINGS

These and other features, aspects, and advantages of the present invention will become apparent from the following description, appended claims, and the accompanying exemplary embodiments shown in the drawings, which are described briefly below.

FIG. 1 shows a perspective view of an airbag according to an embodiment of the present invention.

FIG. 2 shows a side elevational view of an airbag with a top overhang according to an embodiment of the present invention

FIG. 3 shows a side elevational view of an airbag according to an embodiment of the present invention as compared to a conventional airbag.

FIG. 4 shows a front elevational view of the conventional airbag of FIG. 3 as compared to a 50^{th} percentile adult male dummy.

FIG. 5 shows a front elevational view of the airbag according to an embodiment of the present invention of FIG. 3 as compared to a 50^{th} percentile adult male dummy.

FIG. 6 shows a front elevational view of a twin airbag according to an embodiment of the present invention as compared to a 50^{th} percentile adult male dummy.

FIG. 7 shows a front elevational view of a twin airbag according to an embodiment of the present invention as compared to a 50^{th} percentile adult male dummy.

### DETAILED DESCRIPTION

Embodiments according to the present invention will be described with reference to the attached drawings. An effort has been made to use the same reference numbers throughout the drawings to refer to the same or like parts

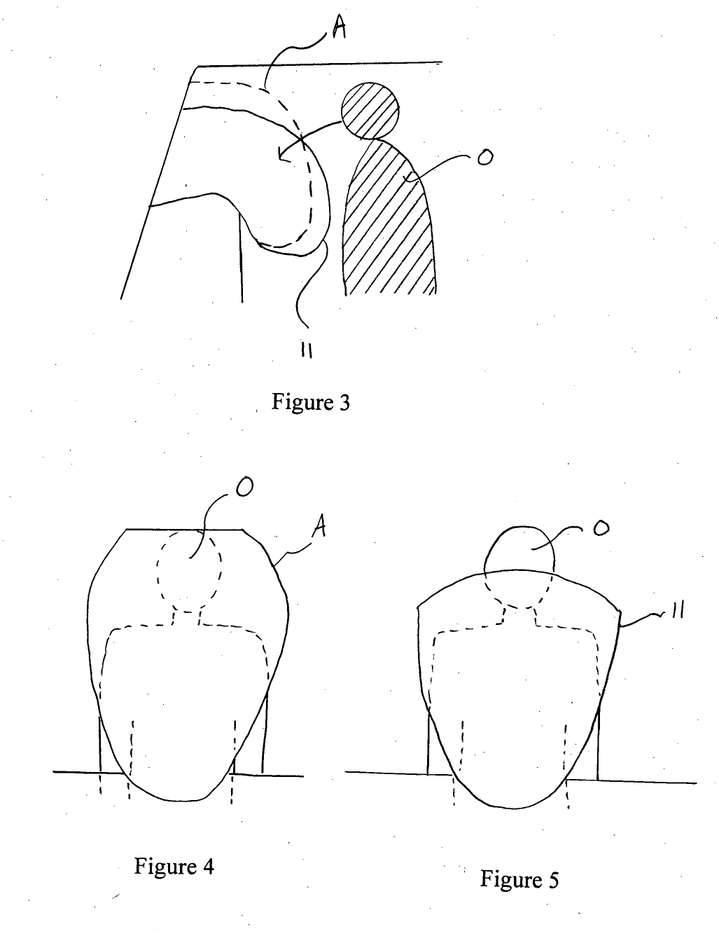

According to an embodiment of the present invention, an airbag device for use in a vehicle to protect an occupant O is provided. The airbag device includes an airbag 11 stored under normal conditions (e.g., stored in an airbag module installed in a vehicle). The airbag 11 may be, for example, a passenger airbag. In the event of an emergency, such as a vehicle collision, the airbag 11 is inflated (shown in FIG. 1) and deployed in a direction toward the vehicle occupant O (shown in FIG. 3). When fully deployed, the profile of the airbag 11 is such that the airbag 11 includes a projected area facing the vehicle occupant O (shown in FIG. 5).

The projected area of the airbag 11 may be approximately 1.0 to 1.4 times a projected area of a 50^{th} percentile adult male dummy. For example, the projected area may be less than approximately 1.3 times the projected area of a 50^{th} percentile adult male dummy; less than approximately 1.2 times the projected area of a 50^{th} percentile adult male dummy; or less than approximately 1.1 times the projected area of a 50^{th} percentile adult male dummy. The standards for the 50^{th} percentile adult male dummy, which are established by the United States Department of Transportation National Highway Traffic Safety Administration, are set forth in 49 C.F.R. §§ 572.5-572.11 (2002), which is incorporated by reference herein.

When the projected area of the airbag 11 is less than 1.0 times the projected area of the 50^{th} percentile adult male dummy, the airbag cannot fully restrain the occupant. Conversely, when the projected area of the airbag 11 is more than 1.4 times the projected area of the 50^{th} percentile adult male dummy, the airbag can impede the occupant when the occupant tries to escape from the vehicle or the airbag takes time to shrink to a size small enough for the occupant to escape from the vehicle. By excluding these projected area ranges, the embodiment described above is able to fully protect the occupant 0 while allowing the occupant O to escape relatively freely after the airbag inflates.

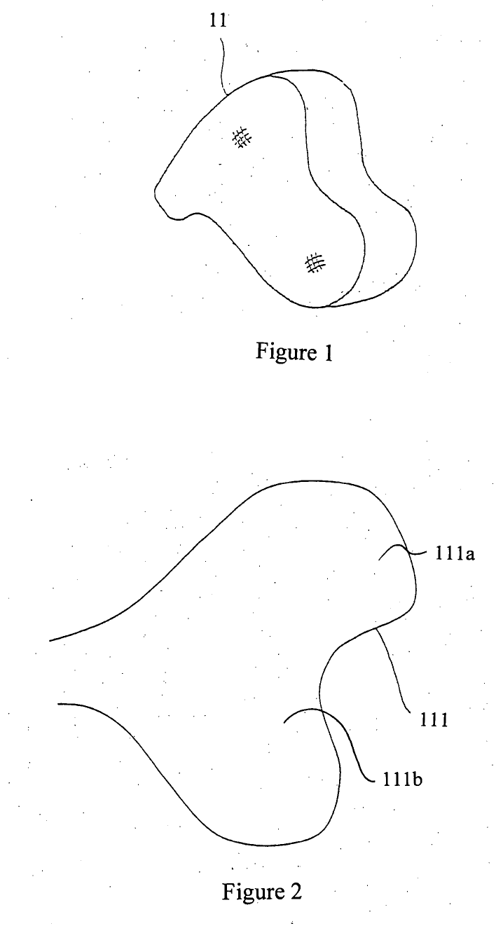

According to another embodiment of the present invention, an airbag 111 is similar to the previous embodiment but has relatively small amounts of fabric because of the airbag characteristics. In this embodiment, as shown in FIG. 2, a portion 111a of the airbag 111 may overhang a main body 111b of the airbag when the airbag 111 is fully inflated. By overhanging the portion 111a of the airbag toward the occupant side when the airbag is inflated, the initial restraint capability of the airbag can be enhanced.

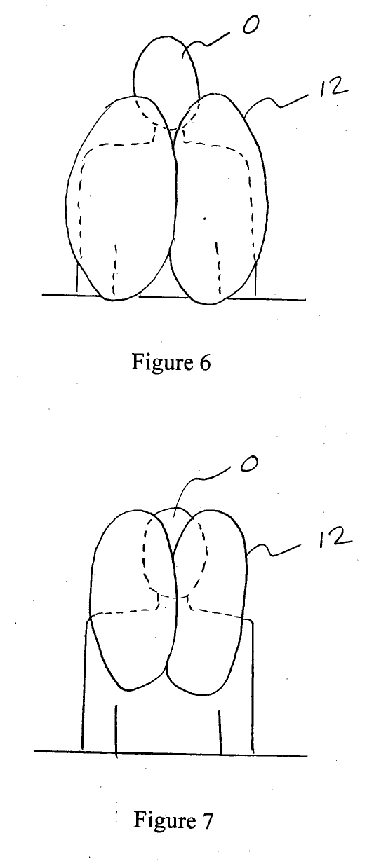

According to another embodiment of the present invention, an airbag device for use in a vehicle to protect an occupant O is provided. The airbag device includes an airbag 12 stored under normal conditions (e.g., stored in an airbag module installed in a vehicle). The airbag 12 may be, for example, a twin airbag as described in U.S. patent application Pub. No. 2004-0145160, incorporated by reference herein, or as described U.S. application Ser. No. 60/517,913, Nov. 7, 2003, incorporated by reference herein. In the event of an emergency, such as a vehicle collision, the airbag 12 is inflated and deployed in a direction toward the vehicle occupant O. When fully deployed, the profile of the airbag 12 is such that the airbag 12 includes a projected area facing the vehicle occupant O, as shown in FIG. 6 (twin airbag) and FIG. 7 (small twin airbag).

The projected area of the airbag 12 may be approximately 1.0 to 2.0 times a projected area of a 50^{th} percentile adult male dummy. For example, the projected area may be less than approximately 1.9 times the projected area of a 50^{th} percentile adult male dummy; less than approximately 1.8 times the projected area of a 50^{th} percentile adult male dummy; less than approximately 1.7 times the projected area of a 50^{th} percentile adult male dummy; less than approximately 1.6 times the projected area of a 50^{th} percentile adult male dummy; less than approximately 1.5 times the projected area of a 50^{th} percentile adult male dummy; less than approximately 1.4 times the projected area of a 50^{th} percentile adult male dummy; less than approximately 1.43 times the projected area of a 50^{th} percentile adult male dummy; less than approximately 1.2 times the projected area of a 50^{th} percentile adult male dummy; or less than approximately 1.1 times the projected area of a 50^{th} percentile adult male dummy.

Although the present invention is generally directed to an airbag which is inflated toward the front side of an occupant, including a driver side airbag, a passenger side airbag, an airbag for occupant's knees, and an airbag for the back seats, the airbag device according to the present invention may be applied to other airbag configurations.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. An airbag device for protecting an occupant of a vehicle, comprising:
a passenger airbag configured to deploy in a direction toward a vehicle occupant in an event of a vehicle emergency,
wherein the passenger airbag when fully deployed includes a projected area facing a vehicle occupant; and
wherein the projected area of the passenger airbag is between 1.0 to 1.4 times a projected area of a 50^{th} percentile adult male dummy.

2. The airbag device of claim 1, wherein the projected area of the passenger airbag is less than approximately 1.3 times the projected area of the 50^{th} percentile adult male dummy.

3. The airbag device of claim 1, wherein the projected area of the passenger airbag is less than approximately 1.2 times the projected area of the 50^{th} percentile adult male dummy.

4. The airbag device of claim 1, wherein the projected area of the passenger airbag is less than approximately 1.1 times the projected area of the 50^{th} percentile adult male dummy.

5. The airbag device of claim 1, wherein the passenger airbag inflates and deploys toward a front of the occupant.

6. The airbag device of claim 1, wherein a portion of the airbag overhangs a main body of the airbag, and wherein the overhung portion overhangs toward the occupant.

7. An airbag device for protecting an occupant of a vehicle, comprising:
a twin airbag configured to deploy in a direction toward a vehicle occupant in an event of a vehicle emergency,
wherein the twin airbag when fully deployed includes a projected area facing a vehicle occupant; and
wherein the projected area of the twin airbag is between 1.0 to 2.0 times a projected area of a 50^{th} percentile adult male dummy.

8. The airbag device of claim 7, wherein the projected area of the twin airbag is less than approximately 1.9 times the projected area of the 50^{th} percentile adult male dummy.

9. The airbag device of claim 7, wherein the projected area of the twin airbag is less than approximately 1.8 times the projected area of the 50^{th} percentile adult male dummy.

10. The airbag device of claim 7, wherein the projected area of the twin airbag is less than approximately 1.7 times the projected area of the 50^{th} percentile adult male dummy.

11. The airbag device of claim 7, wherein the projected area of the twin airbag is less than approximately 1.6 times the projected area of the 50^{th} percentile adult male dummy.

12. The airbag device of claim 7, wherein the projected area of the twin airbag is less than approximately 1.5 times the projected area of the 50^{th} percentile adult male dummy.

13. The airbag device of claim 7, wherein the projected area of the twin airbag is less than approximately 1.4 times the projected area of the 50^{th} percentile adult male dummy.

14. The airbag device of claim 7, wherein the projected area of the twin airbag is less than approximately 1.3 times the projected area of the 50^{th} percentile adult male dummy.

15. The airbag device of claim 7, wherein the projected area of the twin airbag is less than approximately 1.2 times the projected area of the 50^{th} percentile adult male dummy.

16. The airbag device of claim 7, wherein the projected area of the twin airbag is less than approximately 1.1 times the projected area of the 50^{th} percentile adult male dummy.
